(19) United States
(12) Patent Application Publication
(10) Pub. No.: US 2012/0242659 A1
(43) Pub. Date: Sep. 27, 2012

(54) METHOD OF CONTROLLING ELECTRONIC DEVICE VIA A VIRTUAL KEYBOARD

(75) Inventor: PENG-CHUNG SUN, Tu-Cheng (TW)

(73) Assignee: HON HAI PRECISION INDUSTRY CO., LTD., Tu-Cheng (TW)

(21) Appl. No.: 13/427,883

(22) Filed: Mar. 23, 2012

(30) Foreign Application Priority Data
Mar. 25, 2011 (CN) 201110073559.3

(51) Int. Cl. G06T 15/00; G06F 3/02; G06F 3/041

(52) U.S. Cl. 345/419; 345/173; 345/168

(57) ABSTRACT

A device with a touch-sensitive display provides a virtual keyboard having several 3D graphical objects as virtual keys, while 3D graphical objects are displayed on the touch-sensitive display and are three-dimensionally rotatable. When the device detects contact and determines the contact as matching a rotation operation, the 3D image rotates and the device can determine, from the final position into which the 3D image has been rotated, the representative plane of the 3D image. When the key is executed by a selecting operation, the character associated with the representative plane is input to the device.

### BACKGROUND

1. Technical Field

The present disclosure relates to a method of controlling an electronic device, and particularly, to a method of controlling an electronic device via a virtual keyboard.

2. Description of Related Art

Touch-sensitive displays (also known as “touch screens”) are well-known. Portable electronic devices with touch-sensitive displays usually provide users with virtual keyboards, where a virtual keyboard is a group of keys displayed on the screen, as a user interface. In operating the virtual keyboard, users can switch between different virtual keyboards in order to input different characters, such as alphabetical characters, numerical characters, symbolic characters, punctuation characters, or the like.

Referring to FIG. 1A and FIG. 1B, which are schematic views of virtual keyboards displayed on a touch-sensitive display (not shown), a user can switch between a numeric & symbolic mode, and an alphabetical mode by pressing a shift button S. Therefore, the layout of the virtual keyboard changes, like a conventional physical keyboard does.

However, the virtual keyboards are usually limited by the size of the electronic devices. As a result, difficulty and inconvenience in operation is experienced when the user needs to input different kinds of characters, such as a password like “Alb2.C”, because he/she must switch between the modes of the virtual keyboard, which increases the inconvenience. Thus, a simplification of the virtual keyboard process is needed.

### BRIEF DESCRIPTION OF THE DRAWINGS

The components in the drawings are not necessarily drawn to scale, the emphasis instead being placed upon clearly illustrating the principles of a method of controlling an electronic device via a virtual keyboard. Moreover, in the drawings, like reference numerals designate corresponding parts throughout the several views.

FIG. 1A is a schematic view of a virtual keyboard displayed on a touch-sensitive display in prior art.

FIG. 1B is a schematic view of another virtual keyboard displayed on a touch-sensitive display in prior art.

FIG. 2 is a perspective view of an electronic device in accordance with an exemplary embodiment of the present disclosure.

FIG. 3 is a block diagram of the electronic device in accordance with an exemplary embodiment of the present disclosure.

FIG. 4 is a zoomed-in view of the virtual keyboard in FIG. 2, in accordance with an exemplary embodiment of the present disclosure.

FIG. 5 is a schematic view of the 3D rotation of a 3D image, in accordance with an exemplary embodiment of the present disclosure.

FIG. 6 is a flowchart of a method of controlling the electronic device in accordance with an exemplary embodiment of the present disclosure.

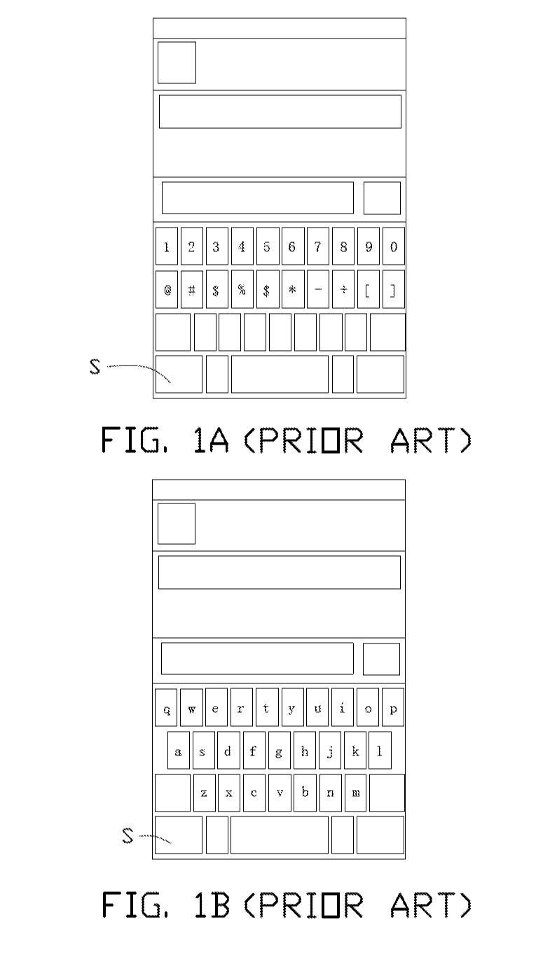

### DETAILED DESCRIPTION

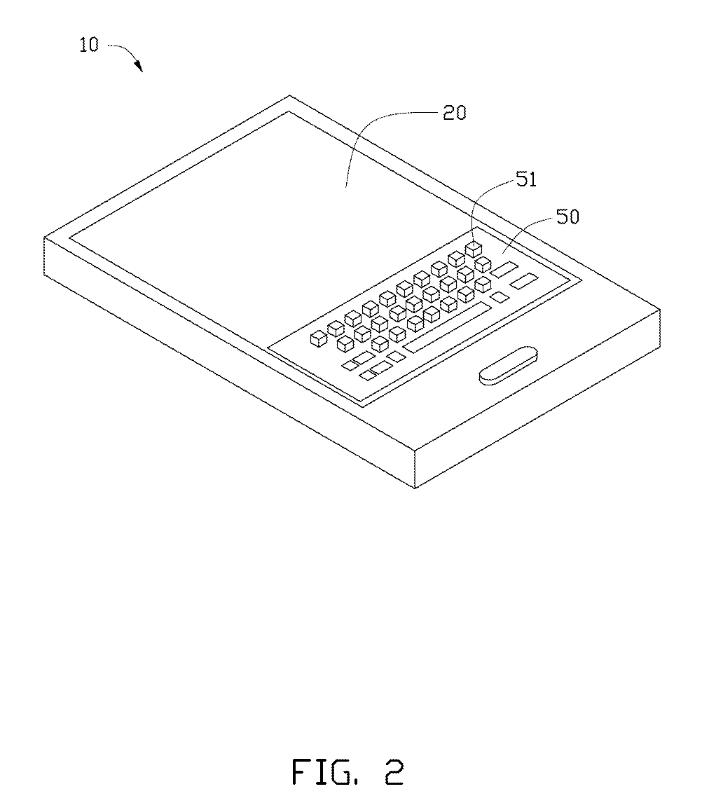

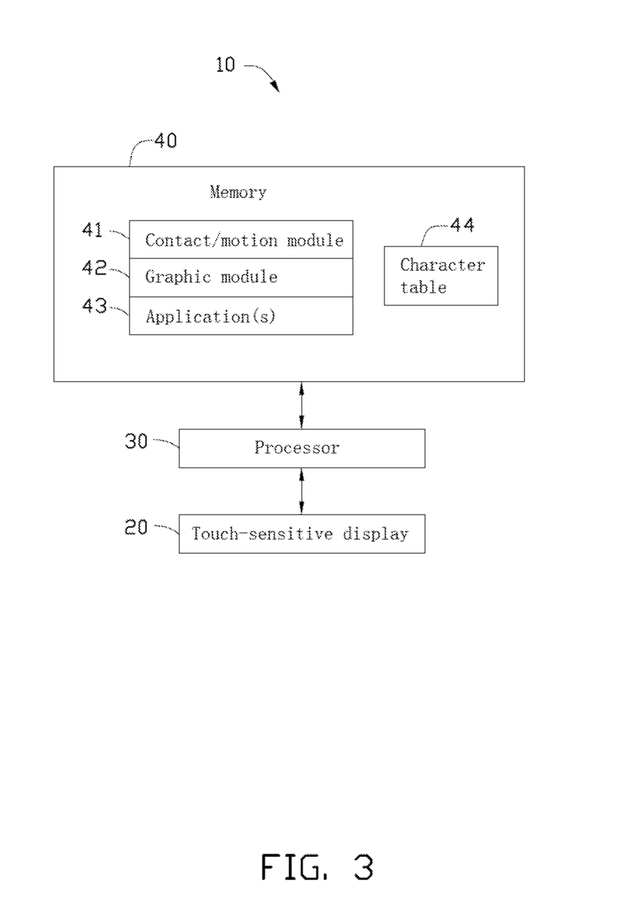

FIG. 2 and FIG. 3 illustrate a portable electronic device according to an embodiment of the disclosure. The electronic device 10 includes a touch-sensitive display 20, one or more processors (CPUs) 30, and a memory 40 in communication with each other. The device 10 can be a portable electronic device, including but not limited to a handheld computer, a tablet computer, a mobile phone, a media player, a personal digital assistant (PDA), or the like, including a combination of two or more of these items.

The touch-sensitive display 20 provides both an output and an input interface between the device 10 and a user. The touch-sensitive display 20 displays visual output to the user, and accepts input from the user based on haptic contact. The memory 40 communicates with the processor 30, while it may include high speed random access memory and may also include non-volatile memory, such as one or more magnetic disk storage devices, flash memory devices, or other non-volatile solid state memory.

In some embodiment, the device 10 includes several software components stored in the memory 40 including a contact/motion module 41, a graphic module 42 and one or more programs (one or more applications 44). Each of the above identified modules and applications correspond to a set of instructions and are configured for execution by the processor 30 to perform one or more functions, as described below.

The contact/motion module 41 detects touches on the touch-sensitive display 20, and includes various software components for certain functions related to the detection of contact made with the touch-sensitive display 20, such as determining if contact has occurred, and determining if the contact has been broken (stopped). The graphic module 42 includes various known software components for rendering and displaying graphics on the touch-sensitive display 20. The one or more applications 43 include a virtual keyboard program. When the virtual keyboard program is running, a virtual keyboard 50 is displayed on the touch-sensitive display 20, the virtual keyboard 50 including a plurality of three-dimensional (3D) virtual buttons and a plurality of two-dimensional (2D) virtual buttons.

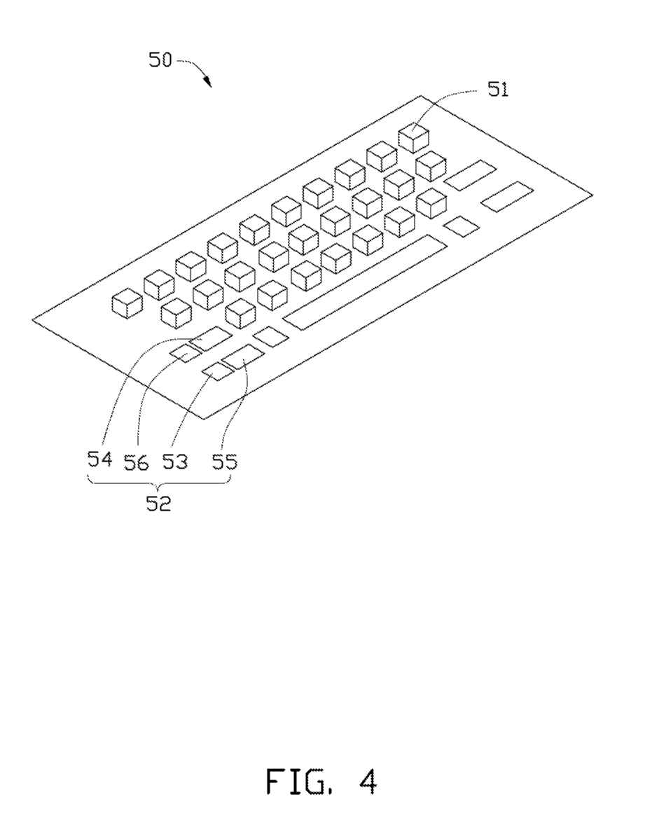

Referring to FIG. 4, in the embodiment of the disclosure, the 3D and 2D virtual buttons of the virtual keyboard 50 are respectively shown as twenty-six virtual keys 51 and a group of general buttons 52, where the group of general buttons 52 includes a rotatable/unrotatable switching button 53, a capitalization mode switching button 54, a numeric mode switching button 55, and a restoring button 56.

Each of the virtual keys 51 appears in a 3D image on the display 20, where the 3D image can be oriented and re-oriented by the graphic module 42 to perform a 3D graphical, inter-surface object with which a user interact to control the device 10. Such 3D graphical objects can be in shape of, but are not limited to, a cube, in the embodiment. The geometric cube has six planes, as does the virtual cube output by the graphic module 42; each virtual key 51 has six graphical planes being numbered by the graphic module 42 as a first plane, a second plane, a third plane, a fourth plane, a fifth plane, and a sixth plane. Each of the aforesaid graphical planes is associated with one of a predefined set of instructions, where the predefined set of instructions includes instructions to input various characters. More specifically, each of the graphical planes is associated with an instruction to input a particular character.

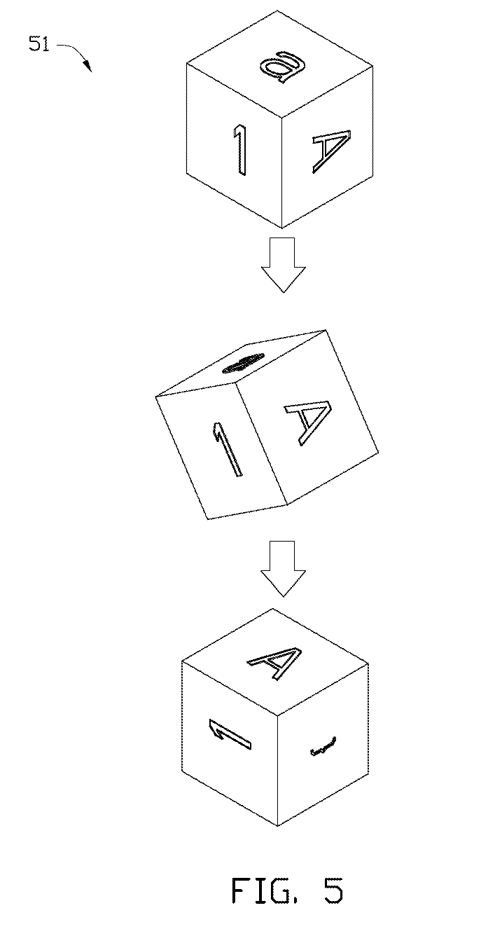

The graphical planes that are currently visible to the user on the display 20 are displayed with the superimposed characters associated therewith, according to a character table 44 stored in the memory 40 and shown below. The aspect of the character matches the aspect of the graphical plane of the cube on which it appears, and thus varies as the 3D image is three-dimensionally rotating (called “cube-rotating hereinafter”), as shown in FIG. 5. The following shows a table 1 which is one example of the character table 44.

TABLE 1

| | Key | | | | | | |
|---|---|---|---|---|---|---|---|
| | Key | Key | Key | Key | | Key | Key |
| Graphical plane | 1 | 2 | 3 | 4 | . . . | 25 | 26 |
| First Graphical | a | b | c | d | . . . | y | z |
| plane | | | | | | | |
| Second Graphical | A | B | C | D | | Y | Z |
| plane | | | | | | | |
| Third Graphical | 0 | 1 | 2 | 3 | | VII | VIII |
| plane | | | | | | | |
| Fourth Graphical | ~ | ! | @ | # | | { | } |
| plane | | | | | | | |
| Fifth Graphical | :) | ; ) | : D | : P | | : ( | : O |
| plane | | | | | | | |
| Sixth Graphical | | | | | | | |
| plane | | | | | | | |

As shown, each first graphical plane of the keys 51 is associated with a lowercase letter (alphabetical character); each second graphical plane of the keys 51 is associated with a capital letter; each third graphical plane of the keys 51 is associated with a numeric character; each fourth graphical plane of the keys 51 is associated with a punctuation character; and each fifth graphical plane of the keys 51 is associated with a combination of symbolic characters. Each sixth graphical plane of the keys 51 is reserved for users to input their own preferred characters, which helps to make the virtual keyboard customizable.

In operating the virtual keyboard 50, first, the user contacts his/her finger with one of the virtual keys 51 of the virtual keyboard 50. The contact/motion module 41 detects contact with the touch-sensitive display 20 and determines whether it is a rotation operation or a selecting operation. The rotation operation satisfies a predefined rotating condition and the selecting condition satisfies a predefined selecting condition. The rotation operation may be predefined as a movement of the point of contact across the touch-sensitive display 20 while maintaining continuous contact with the touch-sensitive display 20. The selecting operation may be predefined as continuous contact on one fixed point which is maintained for less than N seconds, such as 3 seconds, so as to distinguish the selecting operation from the rotation operation.

In another embodiment, the virtual keyboard application program may allow input in a rotatable state or input in an unrotatable state and switch between the two modes. When the virtual keyboard 50 is in the rotatable state, the predefined rotating condition is satisfied, all operations on the keys 51 are by the rotation operation; and when the virtual keyboard 50 is in the unrotatable state, the predefined selecting condition is satisfied, all operations on the keys 51 are by the selecting operation. Such a mode-switching function is provided via the rotatable/unrotatable switching button 53.

As the finger of the user moves across the touch-sensitive display 20 in a particular direction and for a particular distance, the virtual cube rotates through a matching angle and rotational distance, which is calculated and controlled by the graphic module 42, such technology being known in the art.

Referring to FIG. 5, in some embodiment of the disclosure, the key 51 is shown in a standard aspect at first, as shown on the top of the figure. Then the key 51 is rotated as the user has executed a rotation operation on it, as shown in the middle of the figure. For determining a representative plane of the graphical planes, the graphic module 42 may calculate the amount of the pixels of each currently visible graphical plane to generate corresponding value of pixel amount, and compares the values to determine a maximum one thereof, for determining whether the one of the currently visible graphical plane surfaces utilizing the maximum amount of pixels is a representative plane. In another embodiment, the graphic module 42 may determine the one poisoned highest (closest to a predefined borderline) on the touch-sensitive display 20 is a representative plane.

After the representative plane has been determined, as shown on the bottom of the FIG. 5, the graphic module 42 automatically rotates the key 51 back to the standard aspect with the representative plane positioned on the top of the cube, and this action is executed without input from the user. At this time, when the user executes a selecting operation on the key 51, the character “A” and not “a” will actually be selected and input to the device 10.

When the capitalization mode switching button 54 is pressed, the virtual cube is rotated so that all of the keys 51 are positioned with their second graphical plane surfaces face-up as being the representative plane surfaces. Similarly, a numeric mode switching button 55 functions so as to switch the keys 51 into a numeric mode and ready for the inputting of numeric characters. Since the state of each key 51 is changeable, the restoring button 56 is provided for restoring all keys back to a default or original state, which is having their first graphical plane as the representative plane. Otherwise, the keys 51 can be grouped together for rotation purposes.

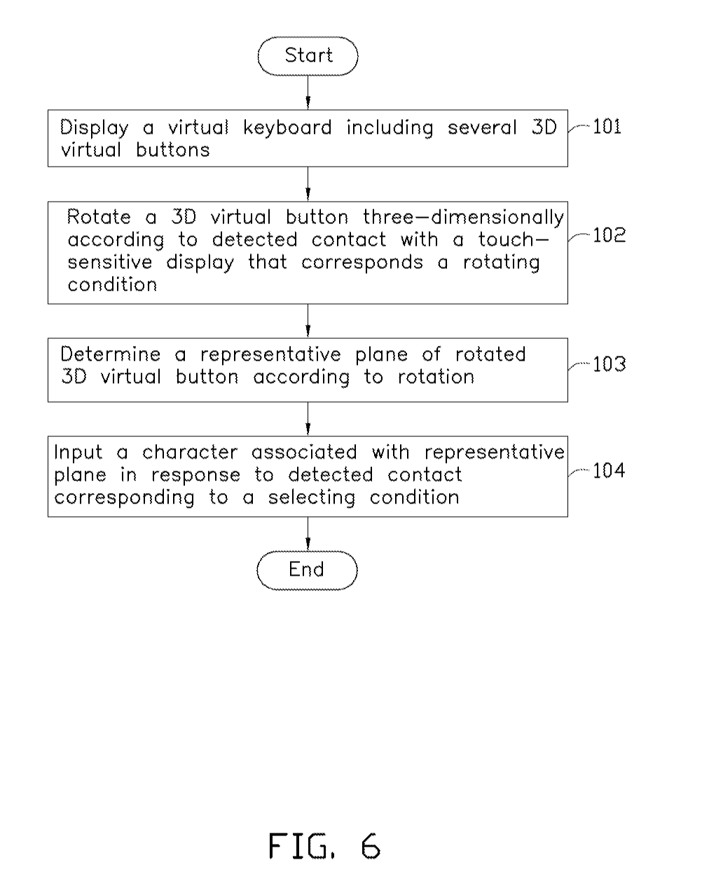

FIG. 6 is a flowchart of the method of controlling an electronic device in the present disclosure. In step 101, the device 10 displays the virtual keyboard 50 including virtual keys 51 (3D virtual buttons) on the touch-sensitive display 20. In step 102, the contact/motion module 41 detects contact with the touch-sensitive display 20 related to one of the keys 51 of the virtual keyboard 50. If the contact corresponds the rotating condition, the contact/motion module 41 determines the contact a rotation operation, and the graphical module 42 accordingly three-dimensionally rotates the key 51, which is a virtual cube having graphical planes. In step 103, the graphical module 42 determines a representative plane of the key 51 from the graphical planes. In step 104, when the key 51 has been selected, inputting the character associated with the representative plane to the device 10. The user selects the key 51 by contact with the touch-sensitive display 20 and the contact corresponds to the selecting condition.

Although the present disclosure has been specifically described on the basis of this exemplary embodiment, the disclosure is not to be construed as being limited thereto. Various changes or modifications may be made to the embodiment without departing from the scope and spirit of the disclosure.

What the claim is:

1. A method for controlling an electronic device comprising a display, the method comprising:
detecting a rotation operation related to a three-dimensional (3D) graphical object displayed on the display, wherein the 3D graphical object comprises a plurality of graphical planes and each of the graphical planes associated with a predefined set of instructions;
rotating the 3D graphical object on the display three-dimensionally according to the rotation operation;
determining a representative plane of the 3D graphical object from the graphical planes of the 3D graphical object; and
performing the instruction associated with the representative plane if a selecting operation related to the 3D graphical object is detected.

2. The method according to claim 1, wherein the electronic device further comprises an input device for operating the rotation operation and the selecting operation.

3. The method according to claim 2, wherein the selecting operation is moving a pointer on the display to the 3D graphical object and inputting a selecting signal to the electronic device.

4. A method for controlling an electronic device comprising a touch-sensitive display, comprising:
displaying a virtual keyboard comprising a plurality of three-dimensional (3D) virtual buttons on the touch-sensitive display;
detecting a contact with the touch-sensitive display;
rotating at least one of the 3D virtual buttons displayed on the touch-sensitive display three-dimensionally in accordance with the detected contact if the detected contact corresponds to a predefined rotation condition, wherein the 3D virtual button is a 3D graphical, interactive user-interface object comprising a plurality of graphical planes, and each of the graphical planes is associated with a character;
determining a representative plane of the rotated 3D virtual button from the graphical planes of the rotated 3D virtual button according to the rotation; and
inputting the character associated with the representative plane of the rotated 3D virtual button in response to detecting contact with the touch-sensitive display that corresponds to a predefined selecting condition.

5. The method according to claim 4, wherein the character is selected from a group composed of numeric characters, symbolic characters, and alphabetical characters.

6. The method according to claim 4, further comprising, transitioning at least one of the 3D virtual buttons to a rotatable state before rotating the 3D virtual button, wherein any detected contact related to the 3D virtual button in the rotatable state is determined to correspond to the predefined rotating condition; and transiting the rotated 3D virtual button to an unrotatable state before inputting the character, wherein any detected contact related to the 3D virtual button in the unrotatable state is determined to correspond to the predefined selecting condition.

7. The method according to claim 4, wherein the detected contact that corresponds to the predefined rotating condition is a movement of a point of contact across the touch-sensitive display while maintaining continuous contact with the touch-sensitive display.

8. A portable electronic device comprising a touch-sensitive display, comprising:
a touch-sensitive display;
memory;
one or more processors; and
one or more modules stored in the memory and configured for execution by the one or more processors, the one or more modules including instructions:
displaying a virtual keyboard comprising a plurality of three-dimensional (3D) virtual buttons on the touch-sensitive display;
detecting contact with the touch-sensitive display;
rotating at least one of the 3D virtual buttons on the touch-sensitive display three-dimensionally in accordance with the detected contact if the detected contact corresponds to a predefined rotating condition, wherein the 3D virtual button is a 3D graphical, interactive user-interface object comprising a plurality of graphical planes, and each of the graphical planes is associated with a character;
determining a representative plane of the rotated 3D virtual button from the graphical planes thereof according to the rotation; and
inputting the character associated with the representative plane of the rotated 3D virtual button in response to detecting contact with the touch-sensitive display that corresponds to a predefined selecting condition.

9. The portable electronic device according to claim 8, wherein the one or more modules further includes instructions: transiting at least one of the 3D virtual buttons to a rotatable state before rotating the 3D virtual button, wherein any detected contact related to the 3D virtual button in the rotatable state is determined to correspond to the predefined rotating condition; and transiting the rotated 3D virtual button to an unrotatable state before inputting the character, wherein any detected contact related to the 3D virtual button in the unrotatable state is determined to correspond to the predefined selecting condition.

10. The portable electronic device according to claim 8, wherein the detected contact that corresponds to the predefined rotating condition is a movement of a point of contact across the touch-sensitive display while maintaining continuous contact with the touch-sensitive display.
